(19) United States
(12) Patent Application Publication
(10) Pub. No.: US 2021/0207398 A1
(43) Pub. Date: Jul. 8, 2021

(54) LOCK STATUS INDICATOR FOR A LOCK OR LATCH FASTENER

(71) Applicant: Frank J. Zamboni & Co., Limited, Brantford (CA)

(72) Inventor: Frank Zamboni, Brantford (CA)

(21) Appl. No.: 16/736,455

(22) Filed: Jan. 7, 2020

(51) Int. Cl. E05B 41/00

(52) U.S. Cl. CPC E05B 41/00

(57) ABSTRACT

A visual status indicator for a fastener which is mounted to a fixed body and which has an element which has an open and a closed position. The visual indicator comprises a two part sheet of marking material having an adhesive surface on one side and a visual status indicator on the other side. One part of the sheet is applied to a surface of the fastener and the other is applied to the fixed body adjacent to the fastener. In one position of the fastener the sheet makes one visual pattern and in the other position a different visual pattern is presented, to clearly visually indicate the status of the fastener.

### FIELD OF THE INVENTION

This invention relates generally to the field of fasteners including locks and latches of the type that may be used to prevent something from being opened. More particularly, this invention relates to indicators for locks and latches which may be used to easily identify the open or closed status of the lock or latch fastener.

### BACKGROUND OF THE INVENTION

Fasteners are used to secure many types of devices. In some cases, the fastener may be in the form of a latch which simply has an open and closed position and in other cases the fastener may be in the form of a key lock, such as a cylinder key lock which may have a locked and unlocked position. In this case, a key may be required to move the lock between a locked and unlocked position or vice versa.

Fasteners of these types may be used on many different forms of enclosures. For example, they may be used on doors, cabinets, machinery, and in many other instances. In the past, attempts have been made to provide a visual indicator of the status of various types of fasteners. An example is the typical door lock indicator on an airplane lavatory in which the lock presents a red coloured occupied symbol in the locked position and presents a green coloured unoccupied symbol in an unlocked position. Typically, this is done by means of a window built into the door and lock structure itself.

Prior art solutions such as this involve complex and relatively expensive mechanical structures as part of the door, lock or fastener itself. Such solutions typically permit an element of the fastener to visibly change between the open and closed positions. Often this change is made visible through a window or opening built into the fastener in combination with a visual element behind the window that changes position between the locked and unlocked positions. This requires, including as a mechanical element, the visual indicator, developing mechanical connections to move the indicator between one position and the next when the status of the lock or fastener changes, and providing a window structure on the device to permit the visual indicator to be visible, amongst other things.

Examples of various such devices and other related devices are found in the following prior patent references: U.S. Pat. Nos. 9,624,693; 9,303,434; 8,037,725; 7,866,195; 6,354,122; 6,349,959; 5,548,984; United States Patent Publication No. US2011/0016938; United States Patent Publication No. US2014/0311197; and United States Patent Publication No. US2015/0240526.

However, there are many applications and uses of locks and latches in which such complex mechanical structures as are required, are simply too complex, expensive and therefore impractical. For example, a medicine cabinet storing doses of pharmaceuticals or a file cabinet with confidential documents may have a simple cylinder key lock. While simple to use and inexpensive it is not possible to tell whether the cabinet is locked or not without physically testing the lock status, by pulling on the drawer, or door, as the case may be. Thus, the person responsible for the security of the contents must continually check the status of the lock manually by going to the closure and seeing if it can be opened or not. If there is frequent access required to the locked contents, the chances of it being accidentally left open are high.

In another example, a latch may be used to secure a cowling for example, on a machine. Again, determining whether the latch is secured or not requires physically testing the latch to see if it is engaged. The risk of the latch being disengaged is that the cover or cowling can become accidentally dislodged at an inopportune moment, perhaps creating a safety issue. There are many other examples of devices that can be latched closed or locked and yet where it is not possible to determine the status without physically testing the lock or latch fastener.

In most cases, for such existing devices, it is impractical to provide a complex mechanical structure with a built-in visual indicator of the sort visible through a form of window to identify of the status of the fastener. As well there are many, many existing storage devices which include simple cylinder locks and/or latches for which an easy indication of the lock status would be desirable, but for which it is impractical to replace the existing lock/latch structures with more complicated and expensive ones of the type that provide a built-in visual indication of lock status as described above. Therefore, some other solution is desired which may be simple, easy to implement, reliable and inexpensive. Preferably such a solution can be applied to existing lock structures without great expense.

### SUMMARY OF THE INVENTION

What is desired is a simple and inexpensive way to provide a status indication of a lock or latch position, without the need to physically test a closure by hand to make sure it is either open or closed as desired.

This invention relates to a simple retrofit indicator which can be applied to an existing cylinder lock or latch for example. The in one embodiment the indicator of the present invention may provide an immediate visual cue as to the status of the fastener: either locked or unlocked or open or closed. In another embodiment the indicator of the present invention may provide a tactile indication of the lock status as explained in more detail below.

In one embodiment the invention may take the form of a decal which is applied to the surface of the lock as well as a surrounding body of the structure in which the lock is housed. The decal may be made from at least two parts, one part being applied to a moveable, for example, rotating lock element, and the other part being applied to the surrounding stationary structure in which the rotating lock part is mounted. The decal part applied to the rotating element may include an opening to permit the key to pass therethrough into the key way in the locking cylinder. The decal may include a preprinted pattern on one side with an adhesive backing on the other side, all mounted to an easy releasing backing layer for ease of shipping and handling.

The decal may display a pattern which is aligned in one lock position and misaligned in the other position. For example, a lock which is normally closed may form a readily discernable pattern in the locked position and be in a disrupted pattern in the unlocked position. Therefore, a simple glance at the visual indicator as applied to the lock can allow a person to determine the status of the pattern, either disturbed or undisturbed which in turn can convey the information as to the lock status. This eliminates the need to physically test the closure to determine if the lock or latch is locked or unlocked or open or closed.

The present invention comprehends a number of distinct visual patterns can be used. Some rotating elements turn 90 degrees and others turn 180 degrees. The patterns suitable for each may vary. By way of example, a solid bar can traverse a latch which turns 90 degrees between open and closed positions. In the closed position the bar is continuous. In the open position the center of the bar is at right angles to the rest of the bar, clearly indicating the latch is open. In another example, two colours may be used with the border extending across the center of the rotating portion of the lock. When the lock is twisted 180 degrees a semicircle of one color may be nested within the other color, which can clearly indicate at a glance that the lock is unlocked, for example. Other patterns may also be used.

In another embodiment the surface of the decal can be textured again having a texture element that is disrupted for the portion that is mounted to the rotating part of the lock or latch when the position of the lock or latch is changed. For example, the surface may include a raised ridge which is rotated 90 degrees when the lock is rotated to the open position. IN another embodiment the surface may include a bias which is discernable to the touch and the rotation of the lock element by 90 or 180 degrees sets the biases of the stationary and rotating portions in different directions. In this way the status of the lock can be detected by the touch, for example of a visually impaired person. The present invention comprehends that both visual and tactile features can be incorporated together in a single indicator.

Therefore, according to one embodiment of the invention there is provided.

In one embodiment the detectable pattern is visual, and in another embodiment the detectable pattern is tactile.

According to a further embodiment of the a lock status indicator for a fastener, wherein the fastener is moveably mounted to a fixed body and the fastener includes at least one element which has open and closed positions, the lock status indicator comprising: a two part sheet of marking material having an adhesive surface on one side and status indicator on the other side and being sized and shaped to be applied to a surface, wherein one part of said sheet is sized and shaped to be applied to a surface of the fastener and the other part is sized and shaped to be applied to a surface of the fixed body adjacent to the one part, wherein the two part marking material forms a detectable pattern, wherein the pattern is complete when the fastener is either open or closed and disrupted when the fastener is in the opposite condition, to provide an indication of the lock status of the fastener present invention there is provided a method of providing a lock status indicator to a fastener mounted to a fixed body, said method comprising the steps of: applying a pattern on a sheet of material which sheet can be divided into at least two parts; sizing and shaping said two parts of said material so as to be able to apply the sheets onto said fastener and said fixed body adjacent to said fastener so said pattern extends over both said fastener and a portion of said fixed body; arranging said pattern on said sheets of material such that when said fastener is in one position the pattern presents in one way and when said fastener is in another position the pattern presents in a way distinct from said one way; and adhering said two parts of said sheet of material to each of fastener and said fixed body by means of an adhesive in the arranged position. According to further embodiments of the invention the method includes applying one or both of a visual and a tactile pattern to the sheet of material.

### BRIEF DESCRIPTION OF THE DRAWINGS

Reference will now be made by way of example only to preferred embodiments of the invention by reference to the following drawing in which:

FIG. 1 is a view of a cylinder lock in a storage cabinet for example;

FIG. 2 is a view of a first embodiment of the present invention applied to the lock structure of FIG. 1;

FIG. 3 is a view of the embodiment of FIG. 1 wherein the lock structure is in the opposite position to that of FIG. 1;

FIG. 4 is a view of a latch structure of a machine hood;

FIG. 5 is a view of a second embodiment of the present invention applied to a latch structure of FIG. 4 one position;

FIG. 6 is a view of the embodiment of FIG. 5 in an opposite position to that of FIG. 5;

FIG. 7 is a schematic view of further type of lock fastener;

FIG. 8 is a view of a further embodiment of the present invention as applied to a cylinder lock shown with an undisturbed pattern comprising the word “LOCK” and

FIG. 9 is a view of the embodiment of FIG. 7 wherein the pattern has been disturbed due to rotation of the cylinder lock;

FIG. 10 is an enlarged cross-sectional view through the invention of FIG. 1 when the visual indicator is still mounted to the easy release backing sheet; and

FIG. 11 is a view from above of the invention of FIG. 10 showing the die cut lines according to one embodiment of the invention.

### DETAILED DESCRIPTION OF THE PREFERRED EMBODIMENTS

The present invention relates to a lock status indicator which may be applied to a fastener. In this specification the term fastener comprehends both locks and latches which may be used to secure access to an enclosure such as a drawer, cabinet, door or cover, among other things. One specific example is a unit dose storage cart, which may be used in hospitals or other medical facilities, for example, to store doses of narcotics. Such carts may be on wheels and include shelves and box dividers which are specifically suited for holding doses of narcotics and other drugs in a handy configuration. Typically, such storage carts must be locked except when a licensed practitioner is removing a dose of medicine for immediate use.

The locks and latches to which the present invention is most suitably applied may be those of the type that are moved between an open and a closed position. In this example, the movement is a rotational movement as described in more detail below. The rotation is typically of an element central to the lock or latch structure, and the region surrounding the rotating element is typically stationary, while the rotating element moves. The present invention is suited for any existing lock or latch structure which has this rotation as a feature between the open and closed positions. As will be comprehended below, rotational movement is not the only type of movement that can be made more easy to detect by the present invention, but since the visual differences between the locked and unlocked positions for fasteners which simply rotate can be difficult to detect otherwise, the present invention is particularly suited to such devices.

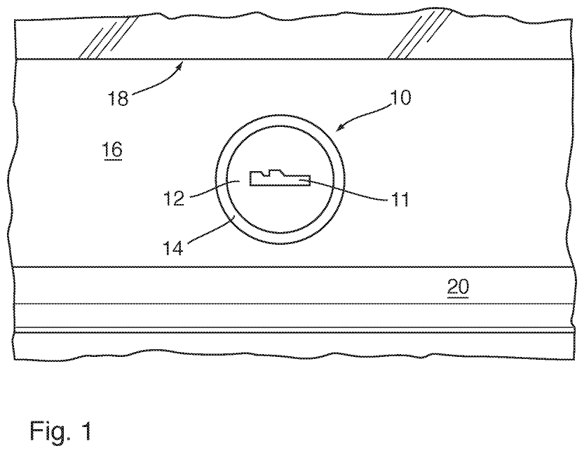

FIG. 1 shows a close-up view of a cylinder or barrel lock of the type that is commonly used on such unit dose storage carts. The cylinder lock indicated generally at 10 includes a key-way 11, within a rotating inner barrel 12 which in turn is housed within a locking sleeve 14. The lock 10 will also include a locking element (not shown) which engages and disengages with a catch internal to the cabinet. In this case the cylinder lock 10 is mounted to a door 16 which includes a window 18. Because the locking mechanics of the cylinder lock are well known, they are not described in any more detail herein. In general, however, this form of lock may require that the key, once inserted with the key way 11, to be rotated 90 and more usually 180 degrees to change the lock status of the cylinder lock, or in other words to lock or unlock the door on the cabinet 20.

Although in FIG. 1 the lock 10 is enlarged making the key-way 11 easy to make out, in practice the key way is quite small and indistinct. Further, it is not always possible to determine from the key-way position alone whether the cylinder lock is in the locked or unlocked position, especially if the key way is rotated 180 degrees. In such cases it is virtually impossible to determine the lock status from the external appearance of the lock alone. Therefore, typically if a person wishes to determine the status of the lock they will need to test it by trying to open the closure or door; if it opens it is unlocked and if it doesn't it is locked. However, in circumstances where it is desired for safety reasons to ensure that the lock is generally in the locked position this constant checking can become tedious. As a result, accidental failure to lock the enclosure may frequently occur. There is no clear indication of the lock status and so there is a chance that the lock could be left unintentionally unlocked.

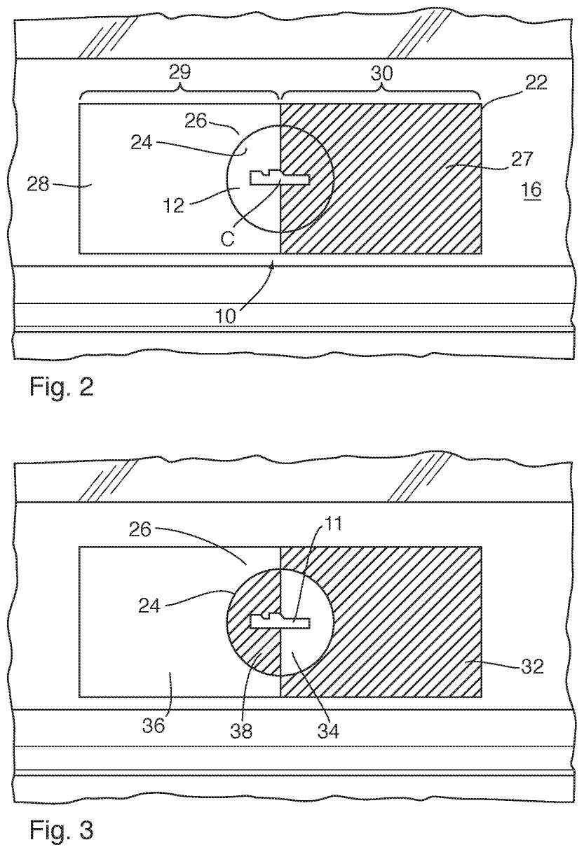

FIG. 2 shows an embodiment of the present invention applied to the cylinder lock 10 of FIG. 1. This embodiment of the invention comprises a sheet 22 to which a visually distinct indication pattern has been applied as explained in more detail below. As described above the cylinder lock fastener 10 is moveably mounted to a fixed body, namely the door 16. The fastener includes at least one element, the rotating inner barrel 12, which rotates between open and closed or locked and unlocked positions. The visual fastener status indicator sheet 22 comprises a two-part sheet of marking material having an adhesive surface on one side and a distinct pattern which can be used as a visual status indicator on the other side. The sheet is preferably sized and shaped to be applied to a surface, wherein one part of said sheet 24 is sized and shaped to be applied to a surface of the rotating inner barrel and the other part 26 is sized and shaped to be applied to a surface of the door adjacent to the rotating barrel.

In this embodiment the sheet includes two distinct colours, such as red 27 and yellow 28 which are easily differentiated by eye. While specific colours are referred to here, it will be understood that the present invention comprehends that the same effect can be achieved by white and black or any other visually contrasting elements or patterns. In this case, the yellow is on the left side and the red is on the right side. The dividing line between the two colours passes through the centre of rotation of the rotating barrel, indicated by the letter C. In FIG. 1 the pattern is aligned to show two solid blocks of colour 29 and 30. However, the solid blocks 29 and 30 are each comprised of two parts, one, 24 mounted to the rotating inner barrel 12 and the other 26 mounted to the door 16. When the barrel 12 rotates the balance of the door structure 16 stays in place. This means that the portion 26 remains in place while the portion 24 rotates with the cylinder lock 12.

Turning now to FIG. 3, this figure depicts the lock of FIG. 2 wherein the rotating barrel has been rotated, by inserting a key into the key way 11 in a known manner and turning the key. In this case, the key has been rotated 180 degrees and the lock status has been changed. If it was locked in FIG. 2, then it is now unlocked. Conversely, if it was unlocked in FIG. 2, then in FIG. 3 it is locked. As can now be appreciated the pattern of FIG. 2 has been disrupted in FIG. 3. Instead of two blocks of colour 29 and 30, the pattern now formed by the rotation of the barrel 12 is a solid rectangle of red 32 surrounding a semicircle of yellow 34 and a solid rectangle of yellow 36 surrounding a semicircle of red 38. Thus, by means of the external application of the visual status indicator of the present invention a simple glance at the lock is enough to determine the lock status. Depending on the choice of the user, either configuration can be the locked or the unlocked position, but it will be clear at a glance what the lock status is without need to test the door to see if it is locked or not. This clear visual status indicator will permit easy identification of the lock status as compared to not having it applied. Further the application of the lock status indicator 22 to the lock 12 can be made easy by using a flat sheet with adhesive on one side to be applied to the lock and surrounding structure and the disruptable pattern on the outer side, which, in this embodiment, is visible to a user.

In this embodiment, the visual indicator sheet 22 of the present invention can be provided on an easy release backing sheet and the patterned top sheet can be applied to the backing sheet to preserve the adhesive during shipping and storage, in a known manner. Most preferably the top sheet will include appropriate die cuts to allow the central circle 24 to be separately applied to the rotating cylinder and the surrounding pattern 26 to be applied to that part of the door structure 16 surrounding the rotating cylinder 12 as described above. Thus, according to one aspect of the present invention, the die cut parts can be sized and shaped to fit over standard sized cylinder locks or known sizes of latches. The present invention comprehends that the die cuts can be complete to allow the stationary portion 26 to be applied separately from the rotating portion 24 of the visual indicator 22, or the die cuts can leave small frangible connections which allow the two portions to be applied simultaneously. In this latter embodiment the turning of the cylinder 12 of the latch or lock element will break the frangible portions allowing free rotation of the two portions 24, 26 of the visual indicator sheet 22 relative to one another.

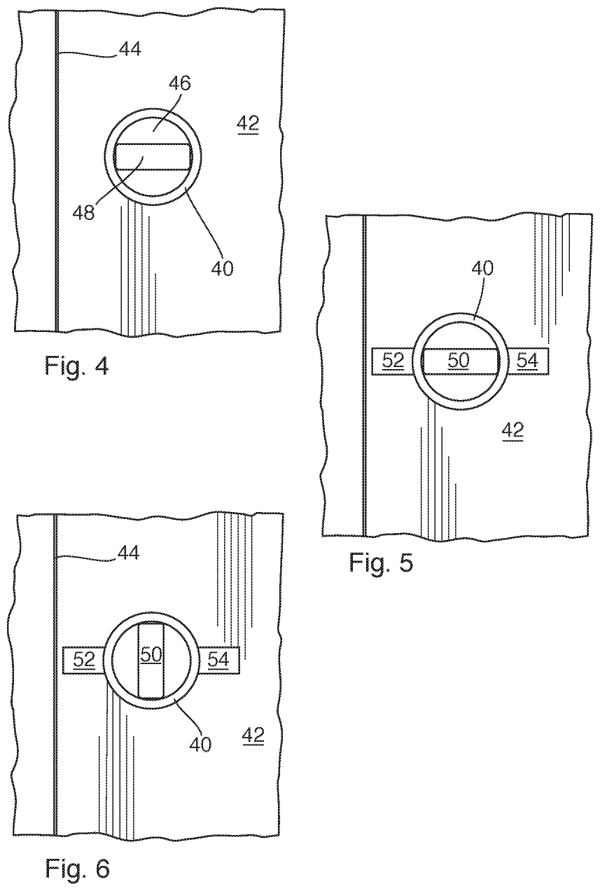

FIG. 4 shows a latch which may be used to secure a cowling on an ice making machine, for example. The latch 40 is mounted to the cowling 42 as shown. When the latch is open, the cowling may be lifted and separated from the main part of the machine along the break line 44. Typically, in use the cowling latch must be closed to protect the machine components. The latch takes the form of a rotating latch element 46, from which extends a finger bar 48. To move the latch between one of open and closed to the other of open and closed, the finger bar must be twisted 90 degrees.

FIG. 5 shows a visual indicator according to the present invention applied to the latch 40 and the cowling 42. In this embodiment the indicator takes the form of a solid coloured bar in one position. Part of the visual indicator is applied on top of the finger bar at 50, and then two other portions are applied on either side of the finger bar at 52 and 54. In one position the elements 52, 50 and 54 are aligned. In this way they create the appearance of a solid bar.

FIG. 6 shows the embodiment of FIG. 5, except that now the finger bar has been rotated by 90 degrees. Thus, the solid bar of FIG. 5 is now a broken bar with the element 50 at 90 degrees in orientation to the elements 52 and 54. This provides an immediate visual indication of the latch status. In one case, the latch might be closed in the configuration of FIG. 5 and open in the configuration of FIG. 6. Thus, it will be immediately obvious to a user that the latch is either open or closed depending upon the position of the visual status indicator as shown in the drawings.

As can now be appreciated, this embodiment shares the use of a distinct pattern, the adhesive backing on the sheet on an opposite side from the distinct pattern and the elements 50, 52 and 54 being cut to the appropriate size to permit 50 to be applied to the moving or rotating part. In this case the elements of the latch may be less common and so this embodiment further comprehends having the end user cut 50, 52 and 54 from a larger sized sheet to be sized and shaped appropriately. While it is preferred the elements 50, 52 and 54 are pre-cut at the manufacturing facility. this may not be possible in all cases for some unusual shapes or sizes of latches and locks. In such cases the present invention comprehends that the elements can be custom sized at the time of application to the fastener.

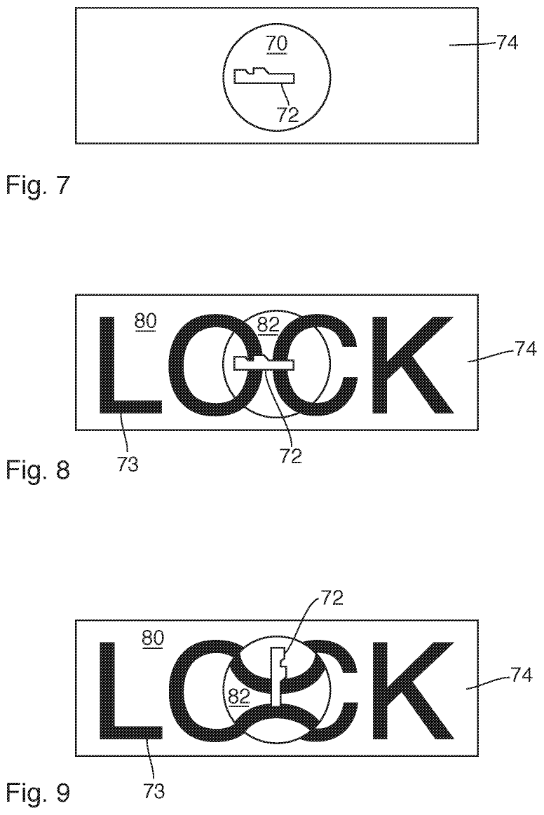

FIG. 7 shows a schematic view of another type of lock fastener. In this case the lock includes a rotating central cylinder 70, with a key-way 72 mounted into a frame 74. As in the previous embodiments this lock is opened and closed by rotating the central cylinder 70 relative to frame 74 which remains stationary. As will be understood by those skilled in the art, the rotation of the central cylinder engages or disengages a locking element on an opposite side of the frame from the key-way thereby locking and unlocking the lock.

In FIG. 8 a visual indicator according to the present invention has been applied to the outside face of the lock frame arrangement of FIG. 7. The visual indicator is provided with a distinct pattern, which in this case is the word LOCK, in block letters at 73. The visual indicator is provided in two parts. One which is mounted to the frame 74 and is indicated as 80, and the other part 82 being mounted to the central rotating cylinder 70. FIG. 8 depicts the lock in the locked position and the word “LOCK” of the visual indicator is whole and easy to read.

In FIG. 9 the central cylinder has been rotated 90 degrees. As a result, the word “LOCK” has been disrupted and it is no longer easy to read what the word is. Thus, at a glance, a person could tell that the lock was in an unlocked state. In this case, because the word used is “LOCK” it makes sense for the word to be legible when the lock status is locked, and illegible when the lock status is unlocked. However, this is not essential, as if the word used was UNLOCKED for example, it would make more sense for the word to be legible in the unlocked state and illegible in the locked state. However, this embodiment demonstrates a further aspect of the present invention in that the visually distinct pattern may include or convey a meaning and that meaning may also be related to the lock status wherein the two-part marking material forms a visible pattern, wherein the pattern is complete when the fastener is either open or closed and disrupted when the fastener is in the opposite condition, to provide a visual indication of the position of the fastener. Thus, in one aspect of the present invention, it may provide a means to include a visual pattern which provides a sense or meaning which is related to the lock status. In this way interpreting the visual design becomes intuitive and may not require much independent explanation.

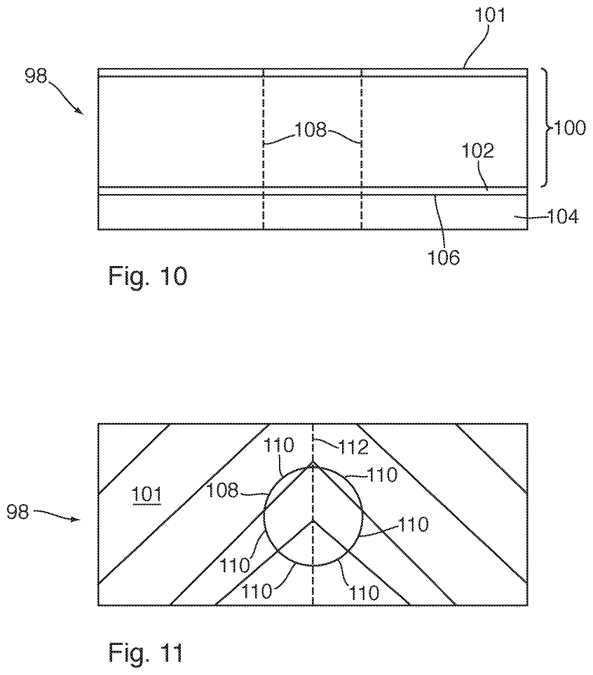

FIG. 10 shows a cross-section through a decal style visual indicator 98 according to one embodiment of the present invention. The top sheet 100 is the part that is applied to the lock structure and surrounding fixed portion of the device. The disruptable pattern is applied to outer surface 101. Then there is a layer of adhesive 102 attached to the top layer 100. Next there is a backing layer 104 which includes an easily release surface 106 from which the adhesive layer 102 can be easily released. Also shown is a die cut 108 which may be sized and shaped to permit the two parts of the top sheet 100 to be separated.

FIG. 11 shows the decal style visual indicator 98 of FIG. 10 in plan view. As shown there are small frangible connections 110 formed between the two portions of the top sheet 100. These connections 110 are sized and shaped to permit the two portions of the visual indictor to be removed from the backing sheet and applied to the lock location as one element. Then, upon the lock or latch being moved, the frangible connections will be broken and the two portions will thereafter be independent from one another. As will be now understood, the adhesive force of the attachment to the outer surface of the lock is much greater that the breaking force required to sever the frangible connections. The dashed line 112 can indicate the border between the two sides of the pattern of the visual indicator 98.

In a further embodiment of the present invention the pattern may also be textured. For example, the letters forming the word LOCK of FIG. 8 could be both visually and physically set apart, for example by being raised, from the background portion of the present invention. In this way of visually impaired person would be able to feel the position of the present invention through a change in texture and thereby be able to determine if the lock was in the open or the closed position, by feeling if the word was complete or disrupted. By way of further example, the present invention comprehends various changes in surface texture such as a raised ridge spanning the lock and a portion of the surface to which the lock is mounted which is aligned when the lock is locked for example and which is not aligned when the lock is open. For locks which rotate through 90° between the open and closed positions this would present the line as continuous in the closed position and with an dissociated orthogonal orientation in the open position. For locks that rotate through 180° for example the present invention provides for a texture with a bias that can be felt with the touch. Therefore, in the open position a portion of the texture on the moving lock mounted part of the invention will be opposite or otherwise dissimilar to the bias of the remaining nonmoving or stationary cabinet-based portion of the present invention. In the locked position the bias would be the same across all portions of the lock status indicator.

While various alterations and modifications of the invention have been discussed above, the true scope of the invention is determined solely by the claims which are attached. Some modifications have been discussed herein, but it will be understood that the specific pattern used can be varied. It can include, text, patterns, colours and other representations which are visible to the eye or sensitive to the touch or both. What is desired is that the pattern be readily discernable and different between the locked and unlocked positions, so the status of the fastener can be easily and readily determined and that the indictor can be applied to many existing locks and fasteners without complication.

What is claimed is:

1. A lock status indicator for a fastener, wherein the fastener is moveably mounted to a fixed body and the fastener includes at least one element which has open and closed positions, the lock status indicator comprising:
a two part sheet of marking material having an adhesive surface on one side and status indicator on the other side and being sized and shaped to be applied to a surface, wherein one part of said sheet is sized and shaped to be applied to a surface of the fastener and the other part is sized and shaped to be applied to a surface of the fixed body adjacent to the one part, wherein the two part marking material forms a detectable pattern, wherein the pattern is complete when the fastener is either open or closed and disrupted when the fastener is in the opposite condition, to provide an indication of the lock status of the fastener.

2. The lock status indicator of claim 1 wherein said detectable pattern is one or more of a visual pattern and a tactile pattern.

3. The lock status indicator of claim 1 wherein the fastener is a lock and the pattern depicts either a locked or unlocked position for said fastener.

4. The lock status indicator of claim 1 wherein the fastener is a latch and the pattern depicts either a closed or open latch position.

5. The lock status indicator of claim 1 wherein said pattern comprises a word which is displayed correctly on one position and said word is disrupted in the other position.

6. The lock status indicator of claim 5 wherein the word conveys a meaning relative to the position of the fastener.

7. The lock status indicator of claim 1 wherein the pattern comprises a solid line when said fastener is in one position and a broken line when said fastener is in the other position.

8. The lock status indicator of claim 1 wherein the pattern comprises two solid colour sections applied to said fastener and said fixed body wherein a line between said solid colour sections is centered on an axis of rotation of said fastener and when said fastener is moved into one position said solid coloured sections are intermixed and when said fastener is in the other position the coloured sections are integral.

9. The lock status indicator of claim 1 wherein said indicator comprises a sheet of material having the visual pattern applied to one surface and adhesive applied to the opposite surface.

10. The lock status indicator of claim 9 wherein said sheet of material is applied to an easy release backing layer for shipping and handling.

11. The lock status indicator of claim 10 wherein said sheet includes one or more die cuts to separate the sheet into said first part and said second part.

12. The lock status indicator of claim 11 wherein said sheet includes frangible connections between said first part and said second part which can be broken upon said sheet being installed on a fastener.

13. The lock status indicator of claim 12 wherein said adhesive attachment is strong enough to break said frangible portions when said visual status indicator is in use.

14. The visual status indicator of claim 1 wherein said parts can be retroactively applied to one or both of a fully installed lock and latch fastener.

15. The lock status indicator of claim 2 wherein the detectable pattern is a tactile pattern and comprises a raised ridge running extending across the stationary and rotating portions of the installed indicator.

16. The lock status indicator of claim 2 wherein the detectable pattern is a tactile pattern and the comprises a bias built into the surface of the installed indicator which bias is detectable by touch.

17. A method of providing a lock status indicator to a fastener mounted to a fixed body, said method comprising the steps of:
applying a pattern on a sheet of material which sheet can be divided into at least two parts;
sizing and shaping said two parts of said material so as to be able to apply the sheets onto said fastener and said fixed body adjacent to said fastener so said pattern extends over both said fastener and a portion of said fixed body;
arranging said pattern on said sheets of material such that when said fastener is in one position the pattern presents visually in one way and when said fastener is in another position the pattern presents in a way visually distinct from said one way; and
adhering said two parts of said sheet of material to each of fastener and said fixed body by means of an adhesive in the arranged position.
